(19) United States
(12) Patent Application Publication
(10) Pub. No.: US 2012/0060183 A1
(43) Pub. Date: Mar. 8, 2012

(54) SYSTEM AND METHOD FOR INTERACTIVE TV ADVERTISING

(76) Inventors: Jennifer Schultz, Johns Creek, GA (US); Charles Dasher, Lawrenceville, GA (US)

(21) Appl. No.: 12/875,759

(22) Filed: Sep. 3, 2010

(51) Int. Cl. H04N 7/10

(52) U.S. Cl. 725/34

(57) ABSTRACT

A system and method for providing interactive television advertising. When a viewer with interactive capability is identified, the system invites the viewer to create an advertisement. When the viewer accepts, the system displays advertisement parameters on the viewer's television or other connected computing device such as a smartphone. The viewer uses a remote control mechanism to select parameters and send them to an interactive advertising unit in a television delivery system. The interactive advertising unit creates the interactive advertisement in accordance with the selected advertisement parameters. The system then shows the interactive advertisement to the viewer during the next commercial break.

### CROSS-REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND

The present invention relates to television (TV) delivery systems. More particularly, and not by way of limitation, the present invention is directed to a system and method for providing interactive television advertising.

Advertisers are looking for ways to get consumers to pay attention to their advertising. When consumers feel like they are a part of the decision-making process, or are otherwise allowed to become “owners” of their advertising experiences, they build stronger connections with the advertised brands.

Advertisers and consumers both have shown past interest in more interactive advertising campaigns. One example is a series of “Old Spice Man” commercials, which had very popular television spots that were augmented by an interactive online campaign in which consumers browsed to a website where they could ask the “Old Spice Man” character a variety of questions, which he would answer in short online videos. An older example of customized interactive advertising is a viral website (hosted by Burger King) where a “subservient chicken” performed actions based on user input. In another advertising campaign, a full-length advertisement would play, ending in a cliffhanger situation, and then the instructions to send a text message, or e-mail to the company would display, in order to choose what would happen next. After a week or so, the most popular selection would play for another week, and so on.

Common to such customized advertising solutions is that they rely on disjoint media. In order to respond to a TV advertisement, the viewer has to use some other communication medium such as the Internet, e-mail, telephone, and the like. There is currently no way in a TV environment to provide a truly interactive experience for the consumer.

### BRIEF SUMMARY OF THE INVENTION

The present invention presents a novel approach to interactive TV advertising. In general, the invention is directed to a system and method for utilizing real-time user input as criteria for advertisement selection and modification. By providing a truly interactive, single-medium experience for the consumer, the consumer is made to feel like he/she is part of the advertising process. Consequently, the consumer forms a stronger bond with the advertised brand, product, or service. Such a single-media customizable solution provides better results than traditional cable TV advertisements and is less expensive to implement since only one form of technology is involved.

In one embodiment, the present invention is directed to a system for providing interactive television advertising. The system includes means for receiving in a Set Top Box (STB) from a viewer, advertisement parameters selected by the viewer for an interactive advertisement; an interactive advertising unit for creating the interactive advertisement in accordance with the selected advertisement parameters; and communication means for sending the selected advertisement parameters from the STB to the interactive advertising unit and for sending the created interactive advertisement from the interactive advertising unit to the STB for showing on a connected television.

In another embodiment, the present invention is directed to a method of providing interactive television advertising. The method includes the steps of receiving by an interactive advertising unit from a viewer, advertisement parameters for an interactive advertisement; creating the interactive advertisement in accordance with the advertisement parameters; and sending the created interactive advertisement from the interactive advertising unit to the viewer.

In another embodiment, the present invention is directed to an interactive advertising unit in a television delivery system for providing a viewer with interactive television advertising. The interactive advertising unit includes means for receiving from the viewer, advertisement parameters for an interactive advertisement; means for creating the interactive advertisement in accordance with the advertisement parameters; and means for sending the created interactive advertisement to the viewer.

The present invention benefits consumers because it enables them to take ownership and engage in the advertising that they see. The invention benefits advertisers because it provides them with a fast, inexpensive way to detect when users are actually interested in their advertisements. The invention benefits service providers such as cable TV companies because they can charge a higher CPM (cost per mil) than for standard advertisements.

### BRIEF DESCRIPTION OF THE SEVERAL VIEWS OF THE DRAWING

In the following section, the invention will be described with reference to exemplary embodiments illustrated in the figures, in which:

FIG. 1 is a flow chart illustrating the steps of an exemplary embodiment of the method of the present invention; and

FIG. 2 is a simplified block diagram of an interactive television delivery system in an exemplary embodiment of the present invention.

### DETAILED DESCRIPTION OF THE INVENTION

In an exemplary embodiment, a viewer is invited to help create an upcoming advertisement for a particular brand, product, or service. The viewer is presented with a list of options to select from and when the selections have been made, the next advertisement for that brand, product, or service includes the viewer's selections. As a result, the viewer feels like he had a part in the process and enjoys immediate gratification by watching the outcome of his work on his TV. The viewer feels more connected to the particular advertisement and by extension, to the brand, product, or service that is being promoted. For example, when watching TV, the viewer sees a quick advertisement stating that in a short while, Audi will be unveiling its new car. The viewer is asked to choose the parameters for the advertisement. For example, the viewer may be able to select a specific celebrity to promote the car, a theme (for example, humor versus dramatic), and so on.

The viewer makes selections on his software remote control mechanism, or hits buttons on a TV remote control device, to interact with an application such as, for example, an Enhanced TV Binary Interchange Format (EBIF) application. The EBIF application, which may be located, for example, at a cable TV provider's head end or in an interactive advertising unit, creates an Audi advertisement utilizing the viewer's parameter selections. Preferably in the next commercial break, the viewer sees the Audi advertisement, created according to his selections.

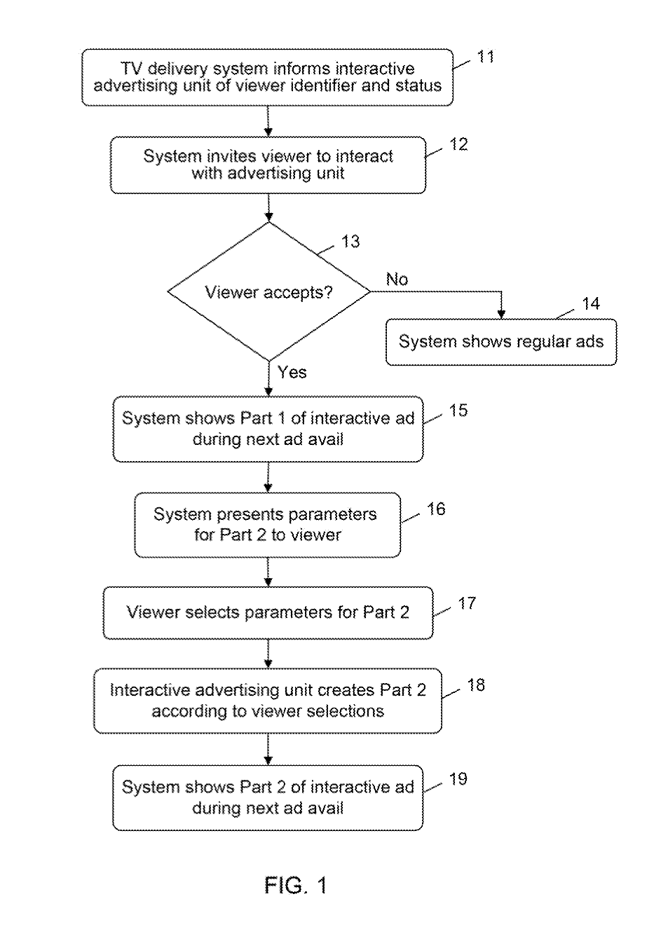

FIG. 1 is a flow chart illustrating the steps of an exemplary embodiment of the method of the present invention. The TV delivery system (for example a cable or satellite TV system) is aware of whether or not the viewer has interactive capability via a software remote control mechanism. At step 11, the TV delivery system provides the viewer's software remote identifier and status to an interactive advertising unit. This may be done when the advertising unit is contacted to fill an ad avail with a selected advertisement. At step 12, if the viewer has interactive capability and if the selected advertisement provides an interactive version, the system invites the viewer to interact with the advertising unit to create an advertisement. This may be done, for example, by sending a text announcement to the viewer's TV and informing the viewer that he can respond using the STB's software remote control mechanism or the viewer's remote control device. Alternatively, a smaller “teaser ad” may be shown inviting the viewer to interact via the software remote control mechanism. After the teaser ad has been shown, the interactive advertisement is queued as the next advertisement to play during an ad avail. At step 13, it is determined whether the viewer accepts the invitation. If not, the method moves to step 14, where the system shows regular (i.e., non-interactive ads). However, if the viewer accepts the invitation, the method moves to step 15 where the system shows Part One of an interactive advertisement (which may be the length of a full advertisement) during the next ad avail.

At step 16, the system presents parameters for Part Two of the advertisement to the viewer and invites the viewer to select parameters for Part Two, scheduled for the next ad avail. At step 17, the viewer inputs his selections using, for example, the viewer's remote control device or an alternative remote control mechanism such as a smartphone or other computing device that communicates with the television delivery system. At step 18, the interactive advertising unit creates Part Two of the advertisement utilizing the EBIF application, for example, and the viewer's parameter selections. This may be done by piecing together different audio/video segments or by selecting a pre-configured advertisement containing the combination of parameters selected by the viewer. At step 19, the system shows Part Two of the interactive advertisement during the next ad avail.

In one embodiment of the invention, the viewer's Set Top Box (STB) is force-tuned to a Video On Demand (VOD) session that plays the viewer's version of the advertisement. In an IP TV system, the STB may temporarily tune to another multicast address to obtain the viewer's version of the advertisement.

The operation of the present invention may be illustrated by an example building upon the “Old Spice Man” commercials discussed above. Rather than requiring the viewer to go to a computer and make inputs to a website, the present invention enables the viewer to make inputs directly through his STB. Options are displayed on the viewer's TV, and he makes selections from them. For example, he may select whether the ‘Old Spice Man” is on a horse or a motorcycle in the next advertisement. Without ever leaving his TV, the viewer can control the content of the next Old Spice advertisement.

With the present invention, the viewer can create an advertising story through his/her answers, choose a product or service to be advertised, or select a particular personality to pitch a product or service. For example, when creating an advertising story, a child viewer may be asked what theme park he would like to visit, and he selects one from a list on the TV. During the next commercial break, there is an advertisement of a fun experience on the rides in that park. In an example for an adult viewer, there may be a beer commercial involving a man and a woman in a bar. The viewer may be given the choices of (a) the man walks up to her and orders two beers; (b) the man orders the beers first, then walks up to her and offers one; or (c) the man talks to her first, then if things go well, orders the beers. The viewer makes his selection, and the next advertisement plays out his selected story.

When choosing a product or service, the viewer may be informed that there will be an automotive advertisement. The viewer chooses between a sports car, minivan, or sedan, and the next advertisement shows the selected car. By combining story creation with product choice, the viewer can see the selected car in a series of different advertisements with different storylines.

The ability to select personalities to pitch a product or service enables the viewer to see a favorite personality or avoid seeing a personality the viewer does not like. This feature can also be combined with the story creation and product choice features for more creative combinations.

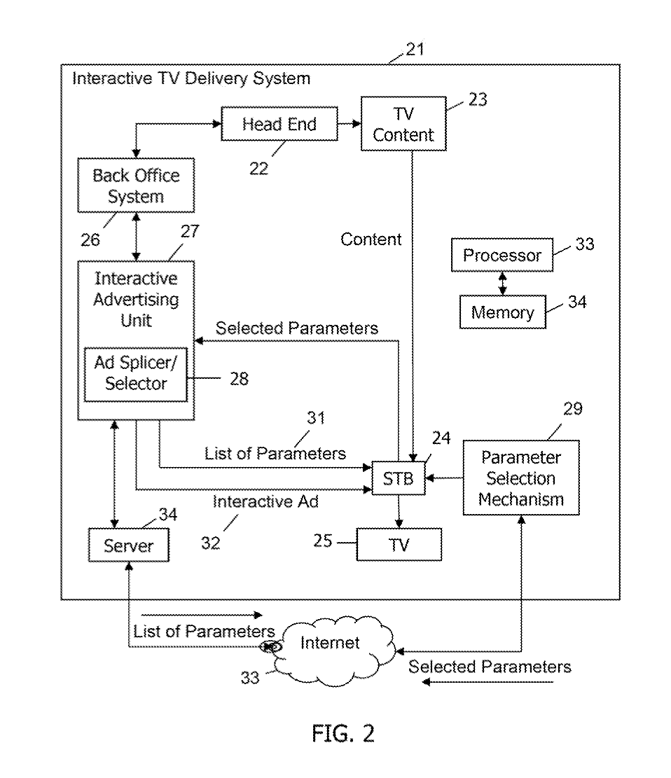

FIG. 2 is a simplified block diagram of an interactive television delivery system 21 in an exemplary embodiment of the present invention. The system includes a head end 22, which delivers TV content 23 to the viewer's STB 24 and TV 25. The system also includes a back office system 26 and an interactive advertising unit 27. The advertising unit includes an ad splicer/selector 28. A parameter selection mechanism 29 (for example, the viewer's remote control device or other computing device) provides viewer selections of advertisement parameters to the STB 24.

As described above, a functional unit of the TV delivery system (for example the back office system 26) provides the viewer's software remote identifier and status to the interactive advertising unit 27. If the viewer has interactive capability and if a selected advertisement provides an interactive version, the system invites the viewer to interact with the advertising unit to create an advertisement. If the viewer accepts the invitation, the system shows Part One of the interactive advertisement during the next ad avail.

The system then presents a list of parameters 31 for Part Two of the advertisement to the viewer and invites the viewer to select parameters for Part Two. The viewer inputs his selected parameters using the parameter selection mechanism 29, and the STB forwards them to the interactive advertising unit 27. The ad splicer/selector 28, which may be implemented as an EBIF application, creates Part Two of the interactive advertisement utilizing the viewer's parameter selections. As noted, this may be done by piecing together different audio/video segments or by selecting a pre-configured advertisement containing the combination of parameters selected by the viewer. The system then shows the interactively created Part Two of the advertisement 32 during the next ad avail.

In an alternative embodiment, the list of parameters may be downloaded from the interactive advertising unit 27 to a computing device functioning as the parameter selection mechanism 29. In this case, the selected parameters may be uploaded to the interactive advertising unit via the Internet 33 and a server 34 in the TV delivery system 21. The server 21 may be located in the Head End 22 or elsewhere in the TV delivery system.

In different embodiments, the interactive TV delivery system 21 is controlled by a processor 35 such as a microprocessor or other suitable processing device executing computer program instructions stored on a memory 36. The instructions may include a software application such as an EBIF application. The EBIF application may alternatively be stored in another location such as the head end 22, or may be embedded within an advertisement.

The present invention creates for the viewer, a customized ad campaign “story”, enables the viewer to choose the advertisements the viewer wishes to view, and enables the viewer to participate in deciding how a product is advertised.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A system for providing interactive television advertising, the system comprising:
means for receiving in a Set Top Box (STB) from a viewer, advertisement parameters selected by the viewer for an interactive advertisement;
an interactive advertising unit for creating the interactive advertisement in accordance with the selected advertisement parameters; and
communication means for sending the selected advertisement parameters from the STB to the interactive advertising unit and for sending the created interactive advertisement from the interactive advertising unit to the STB for showing on a connected television.

2. The system according to claim 1, further comprising means for presenting to the viewer on the television, a list of advertisement parameters from which the viewer selects the advertisement parameters for the interactive advertisement.

3. The system according to claim 2, further comprising a remote control mechanism for selecting advertisement parameters from the list of advertisement parameters presented on the television.

4. The system according to claim 3, wherein the remote control mechanism is a software remote control mechanism of the STB.

5. The system according to claim 3, wherein the remote control mechanism is a television remote control device that sends parameter selections to the STB.

6. The system according to claim 1, wherein the interactive advertising unit includes a segment splicer for splicing together prerecorded advertisement segments corresponding to the selected advertisement parameters.

7. The system according to claim 1, wherein the interactive advertising unit includes an advertisement selector for selecting from a number of prerecorded advertisements, a prerecorded advertisement created according to the selected advertisement parameters.

8. A method of providing interactive television advertising for a viewer, the method comprising the steps of:
receiving by an interactive advertising unit from a viewer, advertisement parameters for an interactive advertisement;
creating the interactive advertisement in accordance with the advertisement parameters; and
sending the created interactive advertisement from the interactive advertising unit to the viewer.

9. The method according to claim 8, wherein the step of creating the interactive advertisement includes creating the interactive advertisement utilizing an Enhanced TV Binary Interchange Format (EBIF) application stored on a memory and executed by a processor.

10. The method according to claim 8, wherein the step of receiving the advertisement parameters from the viewer includes receiving viewer-selected advertisement parameters from a computing device of the viewer via the Internet and a server in the television delivery system.

11. The method according to claim 8, wherein the step of receiving the advertisement parameters from the viewer includes receiving viewer-selected advertisement parameters from a Set Top Box (STB) connected to a television of the viewer.

12. The method according to claim 11, wherein the step of receiving the selected advertisement parameters from the STB includes receiving the selected advertisement parameters via a television remote control device that sends parameter selections to the STB.

13. The method according to claim 8, further comprising, before receiving the advertisement parameters from the viewer, the step of presenting to the viewer, a list of advertisement parameters from which the viewer selects the advertisement parameters for the interactive advertisement.

14. The method according to claim 13, wherein the step of creating the interactive advertisement by the interactive advertising unit includes splicing together prerecorded advertisement segments corresponding to the selected advertisement parameters.

15. The method according to claim 13, wherein the step of creating the interactive advertisement by the interactive advertising unit includes selecting from a number of prerecorded advertisements, a prerecorded advertisement created according to the selected advertisement parameters.

16. An interactive advertising unit in a television delivery system for providing a viewer with interactive television advertising, the interactive advertising unit comprising:
means for receiving from the viewer, advertisement parameters for an interactive advertisement;
means for creating the interactive advertisement in accordance with the advertisement parameters; and
means for sending the created interactive advertisement to the viewer.

17. The interactive advertising unit according to claim 16, wherein the means for creating the interactive advertisement includes an Enhanced TV Binary Interchange Format (EBIF) application stored on a memory and executed by a processor.

18. The interactive advertising unit according to claim 16, wherein the means for receiving the advertisement parameters from the viewer includes means for receiving viewer-selected advertisement parameters from a computing device of the viewer via the Internet and a server in the television delivery system.

19. The interactive advertising unit according to claim 16, wherein the means for receiving the advertisement parameters from the viewer includes means for receiving viewer-selected advertisement parameters from a Set Top Box (STB) connected to a television of the viewer.

20. The interactive advertising unit according to claim 19, wherein the means for creating the interactive advertisement includes a segment splicer for splicing together prerecorded advertisement segments corresponding to the viewer-selected advertisement parameters.

21. The interactive advertising unit according to claim 19, wherein the means for creating the interactive advertisement includes an advertisement selector for selecting from a number of prerecorded advertisements, a prerecorded advertisement created according to the viewer-selected advertisement parameters.

22. The interactive advertising unit according to claim 16, further comprising means for receiving from the television delivery system, a software remote identifier for the viewer and an indication of whether or not the viewer has interactive capability.

23. The interactive advertising unit according to claim 22, further comprising means for sorting advertisements into interactive advertisements and non-interactive advertisements, wherein when the indication indicates that the viewer does not have interactive capability, the interactive advertising unit shows only non-interactive advertisements to the viewer.
